(19) United States
(12) Patent Application Publication
(10) Pub. No.: US 2008/0228493 A1
(43) Pub. Date: Sep. 18, 2008

(54) Determining voice commands with cooperative voice recognition

(76) Inventor: CHIH-LIN HU, Tai-Nan City (TW)

Correspondence Address: NORTH AMERICA INTELLECTUAL PROPERTY CORPORATION, P.O. BOX 506, MERRIFIELD, VA, 22116, US

(21) Appl. No.: 11/685,198

(22) Filed: Mar. 12, 2007

(51) Int. Cl. G10L 11/00

(52) U.S. Cl. 704/275

(57) ABSTRACT

A method of recognizing voice commands cooperatively includes generating a voice command from a user specifying a target machine and a desired action to be performed by the target machine, and a plurality of machines receiving the voice command, the plurality of machines comprising the target machine and at least one member machine. The method also includes each of the plurality of machines performing a recognition process on the voice command to produce a corresponding recognition result, each member machine sending its corresponding recognition result to the target machine, and the target machine evaluating its own recognition result together with the recognition result from each member machine to determine a most likely final recognition result for the voice command.

### BACKGROUND OF THE INVENTION

1. Field of the Invention

The present invention relates to a cooperative voice recognition system and method for enabling several machines to work in cooperation to recognize a spoken voice command.

2. Description of the Prior Art

Voice recognition technology is used mainly in communications and computing. Voice recognition (or speech recognition) technology is designed to recognize the sounds of human speech and convert them into digital signals for processing as input by a computer. In practice, the command system is designed to recognize a few hundred words, which eliminates the need for a mouse or keyboard in performing repetitive operations. Discrete systems, used in dictation, require the speaker to pause between words. Continuous recognition handles natural language at normal speed, but requires considerably more processing capability. Systems capable of understanding large vocabularies spoken at any speed are expected to become mainstream in the foreseeable future.

The voice recognition technology is widely used in robots. From the viewpoint of computer science, the word “robot” means a software robot: a program that runs automatically without human intervention. Typically, a robot is endowed with some artificial intelligence so that it can react to different situations it may encounter. Even though a software robot likely features a voice recognition function, this program can run in any computing device without regard to device surface.

Many voice recognition applications and services have been installed inside electronic devices, such as mobile phones, hand-free electronic equipment, voice dialing equipment, voice navigation in car and so forth. Among others is the voice command system. Unfortunately, users often experience poor recognition accuracy. In many situations, the accuracy may be lower than fifty percent, and is thereby unacceptable. Even though substantial research has been dedicated to increase accuracy to become close to eighty percent, these experiments are conducted upon a complicated voice command recognition algorithm applied into a complicated system requiring a tremendous amount of computing power. This stringent computing power requirement severely limits the kinds of electronic devices that can use voice recognition.

It is not easy to make robot design simple and to attain high recognition accuracy simultaneously. Particularly, most robots are stand-alone: that is, a stand-alone robot is able to perform voice command recognition and serves as the only recognizing device. To attain higher recognition accuracy, a robot needs to be equipped with more computation power and to run a more complicated recognition algorithm. This is not practical however, as mentioned above.

Please note that in the following disclosure, the terms “speech recognition” or “voice recognition” are used interchangeably. The voice source may be from a human speaker or can even be from a machine.

### SUMMARY OF THE INVENTION

It is therefore an objective of the claimed invention to provide a cooperative voice recognition system and related method in order to solve the above-mentioned problems.

According to an embodiment of the claimed invention, a method of recognizing voice commands cooperatively includes generating a voice command from a user specifying a target machine and a desired action to be performed by the target machine, and a plurality of machines receiving the voice command, the plurality of machines comprising the target machine and at least one member machine. The method also includes each of the plurality of machines performing a recognition process on the voice command to produce a corresponding recognition result, each member machine sending its corresponding recognition result to the target machine, and the target machine evaluating its own recognition result together with the recognition result from each member machine to determine a most likely final recognition result for the voice command.

According to another embodiment of the claimed invention, a cooperative voice recognition system for recognizing a voice command from a user specifying a target machine and a desired action to be performed by the target machine is disclosed. The system includes at least one member machine having a first receiving module for receiving the voice command, a first voice recognition module for producing a recognition result based on the voice command, and a first transmitting module for sending the recognition result to the target machine. The target machine includes a second receiving module for receiving the voice command and the recognition result from each member machine, a second voice recognition module for producing a recognition result based on the voice command, and an evaluation module for evaluating the recognition result produced by the first and second voice recognition modules to determine a most likely final recognition result for the voice command.

It is an advantage that the member machines cooperate with the target machine, thereby increasing the processing power that can be used for recognizing voice commands. The member machines can be directly neighboring the target machine, or can remotely communicate with the target machine through a network.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a cooperative voice recognition system according to the present invention.

FIG. 2 is a functional block diagram of the member machines.

FIG. 3 is a functional block diagram of the target machine.

FIG. 4 is a sequence diagram illustrating operation of the cooperative voice recognition system according to a first embodiment of the present invention.

FIG. 5 is a sequence diagram illustrating operation of the cooperative voice recognition system according to a second embodiment of the present invention.

### DETAILED DESCRIPTION

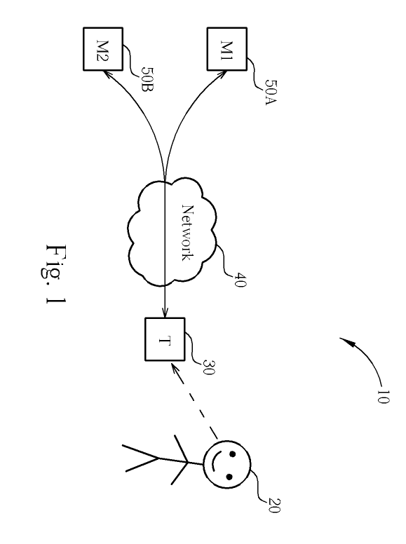

Please refer to FIG. 1. FIG. 1 is a block diagram of a cooperative voice recognition system 10 according to the present invention. The system 10 contains a network 40 that allows communication between a target machine 30, a first member machine 50A, and a second member machine 50B. Please note that the network 40 can be a wireless network, a wired network, or any combination of the two. In general, a user 20 issues a voice command for an action that is to be performed by the target machine 30. The target machine 30 then receives assistance from the member machines 50A, 50B in recognizing the voice command. The member machines 50A, 50B can receive the voice command either directly from the user if the member machines 50A, 50B are in close proximity to the user, or can receive the voice command from the target machine 30 via the network 40. The target machine 30 and the member machines 50A, 50B can each be robots or any other machines that are capable of performing voice command recognition.

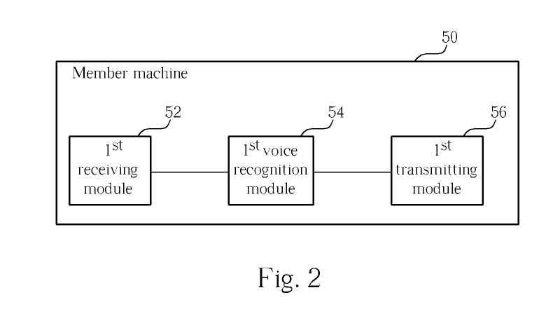

Please refer to FIG. 2. FIG. 2 is a functional block diagram of the member machines 50. Each member machine 50 has the same basic functionality, although they do not have to be identical to one another. The member machine 50 contains a first receiving module 52 for receiving voice commands, a first voice recognition module 54 for producing a recognition result based on the received voice command, and a first transmitting module 56 for sending the recognition result to the target machine 30.

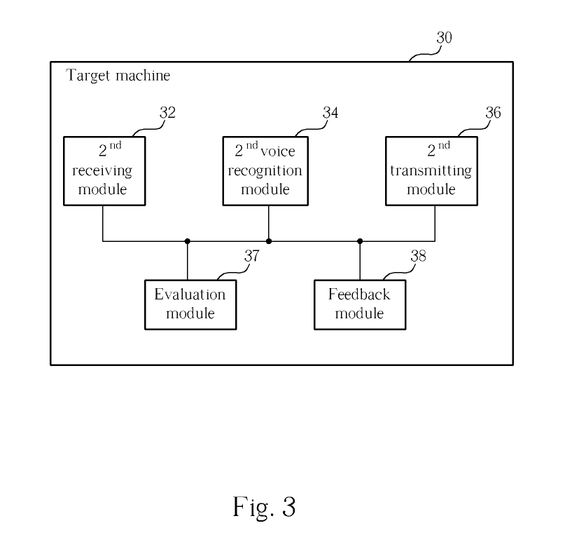

Please refer to FIG. 3. FIG. 3 is a functional block diagram of the target machine 30. The target machine 30 has the same basic functionality as the member machine 50, but contains additional functions for evaluating the recognition results of both the target machine 30 and the member machines 50A, 50B. The target machine 30 contains a second receiving module 32 for receiving the voice command from the user 20. The second receiving module 32 also receives the recognition result from each of the member machines 50A, 50B after the member machines 50A, 50B have produced their respective recognition results. The target machine 30 also contains a second voice recognition module 34 for producing the target machine's own recognition result based on the received voice command. An evaluation module 37 is used to evaluate the recognition results produced by the first voice recognition modules 54 of the member machines 50A, 50B along with the second voice recognition module 34 of the target machine 30. The evaluation module 37 determines a most likely final recognition result for the voice command based on the received set of recognition results. The target machine 30 also has an optional feedback module 38 for receiving feedback from the user 20 indicating whether an action performed by the target machine 30 matched the action indicated by the voice command. The feedback module 38 also fine-tunes parameters used by the evaluation module 37 for determining the most likely final recognition result for the voice command according to the user's feedback. In this way, the voice command recognition system can be continually improved with feedback from the user 20.

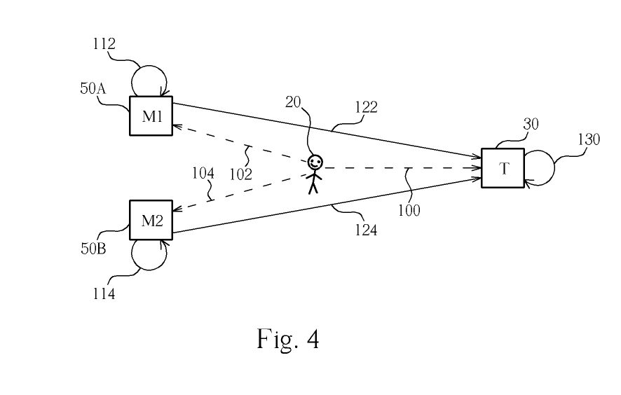

Please refer to FIG. 4. FIG. 4 is a sequence diagram illustrating operation of the cooperative voice recognition system 10 according to a first embodiment of the present invention. In the first embodiment, the member machines 50A, 50B and the target machine 30 are in close proximity to the user 20 and each machine is able to receive the voice command directly from the user 20. That is, the user broadcast voice signal to the machines. While the user 20 issues a voice command directly to the target machine 30 (arrow 100), the first member machine 50A (arrow 102) and the second member machine 50B (arrow 104) can also receive the voice command from the air. The first member machine 50A produces its own recognition result according to the received voice command (arrow 112), and the second member machine 50B does the same (arrow 114). The first member machine 50A and the second member machine 50B then send their recognition results to the target machine 30 (arrows 122, 124) over the network 40. The target machine 30 also produces its own recognition result according to the voice command and then determines the most likely final recognition result for the voice command based on all of the recognition results (arrow 130).

As shown above, the target machine 30 should receive the recognition results from member machines. In one embodiment, after the member machines 50A, 50B receive the voice command from the user 20, the member machines 50A, 50B forward their recognition results to the target machine 30. This means that the member machines are made to specify the target machine. For instance, in the voice command, the target machine 30 is specified. This can be accomplished by the user 20 stating the name of the target machine 30 and then stating the action that is to be performed. Additionally, a target machine 30 could be specified by default if no machine name is given. Moreover, the target machine 30 may broadcast a signal beforehand to identify itself as the target machine to the member machines. In another embodiment, the member machines 50A, 50B can broadcast their recognition results and thus the target machine 30 can receive the recognition results from the air.

There may also be the situation in which the member machines 50A, 50B may miss part of the voice command. If the member machines 50A, 50B miss the name of the target machine 30 and there is no default machine specified as the target machine 30, the member machines 50A, 50B broadcast the recognition result on the network 40 as described above. The target machine 30 then detects this broadcast, and receives the recognition result. If the member machines 50A, 50B miss the action specified in the voice command, the member machines 50A, 50B can sit idle without sending a recognition result to the target machine 30. In the worst case, if there is no cooperation received from any of the member machines 50A, 50B, the target machine 30 will use only its own recognition result to perform the voice command recognition.

When the evaluation module 37 of the target machine 30 evaluates all of the recognition results to determine the most likely final recognition result for the voice command, a variety of schemes can be used for deciding which voice command is the most likely. For example, suppose that the voice command is a phrase containing three distinct words. The evaluation module 37 can count the results for each of the three word positions to determine which words were most likely stated for each of the three word positions. The words in each of the three word positions that were most frequently recognized are selected to be the final recognition result. Please keep in mind that a variety of other evaluation methods can be used instead of or in addition to the method described above.

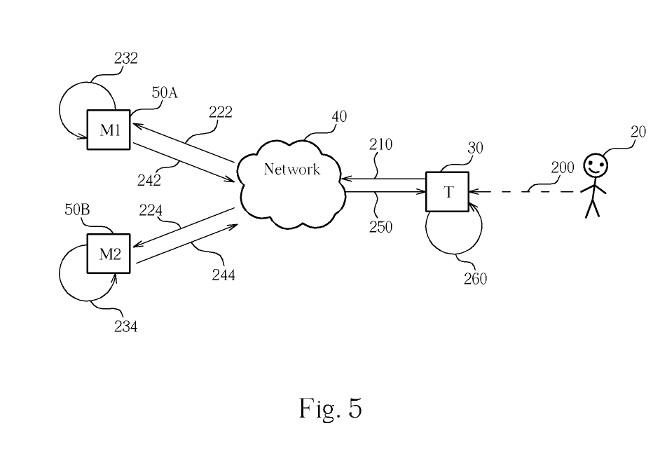

Please refer to FIG. 5. FIG. 5 is a sequence diagram illustrating operation of the cooperative voice recognition system 10 according to a second embodiment of the present invention. In the second embodiment, the member machines 50A, 50B can be anywhere in the world, and only the target machine 30 is in close proximity to the user 20. The user 20 issues a voice command directly to the target machine 30 (arrow 200). The target machine 30 then sends the received voice command to the network 40 (arrow 210) for delivery to the first member machine 50A (arrow 222) and the second member machine 50B (arrow 224). The first member machine 50A produces its own recognition result according to the received voice command (arrow 232), and the second member machine 50B does the same (arrow 234). The first member machine 50A and the second member machine 50B then send their recognition results to the network 40 (arrows 242, 244) and on to the target machine 30 (arrow 250). The target machine 30 then produces its own recognition result and also determines the most likely final recognition result for the voice command based on all of the recognition results (arrow 260).

With the second embodiment, the member machines 50A, 50B can be located anywhere so long as they are connected to the network 40. This allows the target machine 30 to take advantage of other computers worldwide that have exceptional computational power, thereby producing a more accurate voice command recognition result.

In summary, the present invention provides a way for multiple machines to work cooperatively in order to more accurately perform voice command recognition. Member machines having higher processing power can be used to aid the target machine in determining the spoken commands. In addition, the member machines are not limited to any specific location, and can communicate with the target machine through a network.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of recognizing voice commands cooperatively, the method comprising:
generating a voice command from a user specifying a target machine and a desired action to be performed by the target machine;
a plurality of machines receiving the voice command, the plurality of machines comprising the target machine and at least one member machine;
each of the plurality of machines performing a recognition process on the voice command to produce a corresponding recognition result;
each member machine sending its corresponding recognition result to the target machine; and
the target machine evaluating its own recognition result together with the recognition result from each member machine to determine a most likely final recognition result for the voice command.

2. The method of claim 1, further comprising:
the target machine performing an action according to the most likely final recognition result of the voice command;
the target machine receiving feedback from the user indicating whether the action performed matched the desired action; and
the target machine fine-tuning its evaluation algorithm for determining the most likely final recognition result for the voice command according to the user's feedback.

3. The method of claim 1, wherein the plurality of machines receiving the voice command comprises:
the target machine directly receiving the generated voice command from the user.

4. The method of claim 3, further comprising:
transmitting the voice command to each member machine by the target machine through a data network; and
sending corresponding recognition results from each member machine to the target machine through the data network.

5. The method of claim 3, wherein the plurality of machines receiving the voice command comprises each member machine directly receiving the generated voice command from the user.

6. The method of claim 5, wherein each member machine sends its corresponding recognition result to the target machine through a data network.

7. The method of claim 5, wherein each member machine sends its corresponding recognitions result in broadcast signals and the target machine receives the recognition results in the broadcast signals from each member machine.

8. A cooperative voice recognition system for recognizing a voice command from a user specifying a target machine and a desired action to be performed by the target machine, the system comprising:
at least one member machine, comprising:
a first receiving module for receiving the voice command;
a first voice recognition module for producing a recognition result based on the voice command; and
a first transmitting module for sending the recognition result to the target machine; and
the target machine, comprising:
a second receiving module for receiving the voice command and the recognition result from each member machine;
a second voice recognition module for producing a recognition result based on the voice command; and
an evaluation module for evaluating the recognition results produced by the first and second voice recognition modules to determine a most likely final recognition result for the voice command.

9. The system of claim 8, wherein the target machine further comprises a feedback module for receiving feedback from the user indicating whether an action performed by the target machine according to the most likely final recognition result of the voice command matched the desired action, and for fine-tuning parameters used by the evaluation module for determining the most likely final recognition result for the voice command according to the user's feedback.

10. The system of claim 8, wherein the target machine further comprises a second transmitting module, and the target machine directly receives the generated voice command from the user through the second receiving module and transmits the voice command directly to the first receiving module of each member machine through the second transmitting module.

11. The system of claim 10, wherein the second transmitting module of the target machine transmits the voice command to the first receiving module of each member machine by the target machine through a data network, and each member machine sends its corresponding recognition result from the first transmitting module to the second receiving module of the target machine through the data network.

12. The system of claim 10, wherein each member machine directly receives the generated voice command from the user through the first receiving module.

13. The system of claim 12, wherein each member machine sends its recognition result from the first transmitting module to the second receiving module of the target machine through a data network.

14. The system of claim 12, wherein each member machine sends its corresponding recognitions result from the first transmitting module in broadcast signals and the second receiving module of the target machine receives the recognition results in the broadcast signals from each member machine.
